(19) United States
(12) Patent Application Publication
(10) Pub. No.: US 2023/0198862 A1
(43) Pub. Date: Jun. 22, 2023

(54) METHOD FOR PROCESSING A DATA PACKET IN A COMMUNICATION NETWORK, METHOD FOR PROCESSING A REQUEST TO CHANGE THE QUALITY OF SERVICE LEVEL OF A CONNECTION, METHOD FOR REQUESTING TO CHANGE THE QUALITY OF SERVICE LEVEL OF A CONNECTION, METHOD FOR MANAGING A QUALITY OF SERVICE, CORRESPONDING DEVICES, SYSTEM AND COMPUTER PROGRAMS

(71) Applicant: ORANGE, ISSY LES MOULINEAUX (FR)

(72) Inventors: Apostolos KOUNTOURIS, CHATILLON (FR); Philippe SURBAYROLE, CHATILLON (FR)

(21) Appl. No.: 18/069,477

(22) Filed: Dec. 21, 2022

(30) Foreign Application Priority Data
Dec. 22, 2021 (FR) 2114215

(51) Int. Cl. H04L 41/5006; H04L 47/2408; H04L 45/02

(52) U.S. Cl. CPC H04L 41/5006; H04L 45/02; H04L 47/2408

(57) ABSTRACT

A method for processing a data packet exchanged between an item of client terminal equipment and an item of server equipment in a communication network, which the item of client equipment accesses via a first communication network, a first quality of service level being intended to be applied to the data packet. The method is implemented by an item of routing equipment of the first communication network and includes: detecting in the data packet at least one item of activation information of a second quality of service level to be applied to the data packet; obtaining a quality of service management rule according to the second quality of service level, associated with the item of activation information; applying the second quality of service level to the routing of the data packet according to the obtained rule, instead of the first quality of service level.

### 1. FIELD OF THE INVENTION

The present disclosure lies in the field of telecommunications, and in particular in the field of managing the quality of service associated with an access of an item of client equipment to a communication network.

In particular, the present disclosure relates to the processing of data packets exchanged between that item of client equipment and an item of server equipment via the communication network and the management of a quality of service for routing such data packets in the communication network.

It applies in particular, but not exclusively, to a communication network implementing the IP (Internet Protocol) communications protocol.

### 2. PRIOR ART AND ITS DISADVANTAGES

Currently, in order for two items of terminal equipment, for example two computers, to exchange data over the Internet communication network, each of them must have previously taken out a contract or a subscription with an Internet access provider or IAP operator. This contract allows them to connect to the operator’s communication network and, through this network, to the Internet, under given Quality of Service or QoS conditions.

According to a simplified view, for example in an all-IP communication network, these exchanges take place between an item of client equipment and an item of server equipment on the basis of so-called IP data packets that go from a source IP address, for example that of the item of client equipment, to a destination IP address, for example that of the item of server equipment. Quality of service level means a level of resources allocated by the network for routing the data streams transmitted or received by the item of equipment in question, via the communication network. It can be measured by different types of metrics, such as a data rate measured in bits/sec and/or a monthly data volume in MBytes allowed and/or a quantity of resource elements, such as physical resource blocks PRBs in a cellular radio access network.

Very often, the item of client equipment and the item of server equipment do not have the same quality of service level. As a result, the quality of service of the connection between the two items of equipment is limited by the lower quality of service level. Such a limitation or asymmetry may at first sight seem normal, but in fact it hinders the development of digital activities (e-commerce, e-learning, etc.) and goes against a modern and inclusive vision of the Internet.

However, it results in restricting the capacity of some client equipment to access services offered by server equipment, which can have major drawbacks in an increasingly dematerialised and connected world, where it is sought to facilitate e-commerce, teleworking and more generally to replace traditional processes progressively with their dematerialised equivalents available via the Internet.

For example, an item of client equipment such as a smartphone may benefit from a low QoS contract, with a low monthly data volume allowed. Once this volume has been consumed, its access to the Internet network is no longer authorised or at best reduced to a very low data rate, which no longer allows it to connect to a commercial site or to benefit from a telemedicine consultation or, for a young person with a limited or prepay plan, to access school remotely, etc. It is understood that, increasingly, this QoS asymmetry and the resulting limitations on the actual quality of service level of the connection between the item of client equipment and the item of equipment are perceived as a hindrance to the development of online services. In particular, it is pushing IT and e-commerce giants to work on alternative solutions, based for example on proprietary network infrastructures that would allow them to reach all these potential customers. The emergence of such solutions may eventually put telecommunication network operators in a difficult position in their own markets.

One or more exemplary embodiments of the present disclosure improves the situation.

### 3. SUMMARY

An exemplary embodiment of the present disclosure responds to this need by proposing a method for processing a data packet exchanged between an item of client terminal equipment and an item of server equipment of a communication network, which the item of client equipment accesses via a first communication network, a first quality of service level being intended to be applied to said data packet.

Said method is implemented by an item of routing equipment of said first communication network and comprises:
detecting in said data packet at least one item of activation information of a second quality of service level to be applied to said data packet;
obtaining a quality of service management rule according to the second quality of service level, associated with said item of activation information; and
applying the second quality of service level to the routing of said data packet according to the obtained rule, instead of the first quality of service level.

An exemplary embodiment of the present disclosure thus proposes a completely new and inventive approach to managing the quality of service of a communication between an item of client equipment and an item of server equipment, each of which accesses a communication network with distinct quality of service levels. It consists in defining for the item of client equipment a second quality of service level intended to be applied to data exchanges between the item of client equipment and the item of server equipment, regarding this connection. Contrary to the prior art, the quality of service level to be implemented for routing the data from and to the item of client equipment is no longer, as in the prior art, that set by the subscription the user of the item of client equipment has taken out with their Internet access provider, but this second quality of service level is specifically determined by a contract taken out by the user or the company managing the item of server equipment.

The quality of service management rule according to the second quality of service level may have been previously obtained and stored in memory. For example, it was installed by a quality of service management entity of the first network configured to manage the update mechanism of a connection of an item of terminal equipment according to an exemplary embodiment and to respond to a request to update the connection of an item of client equipment. When it has been established that the request is valid, the entity installs the rule in the item of routing equipment or stores it in memory.

In this way, an exemplary embodiment of the present disclosure triggers a specific quality of service management for communications between a client and a server, determined by the destination (the server) which replaces the quality of service management provided for by the contract taken out by the user of the item of client equipment (the source).

It thus offers a facilitated connection solution, which rebalances the existing asymmetry between the quality of service level to which the item of client equipment is entitled and the higher one of the item of server equipment, and provides the item of client equipment with a better access to the services of the item of server equipment.

An exemplary embodiment of the present disclosure thus lays the foundations for a new telecommunications service that would have numerous applications, whether for e-commerce, distance learning or telemedicine. It also has applications in B2B relationships, for example to ensure a uniform access to a private company network, such as a VPN, for all employees.

It is particularly interesting for communication networks, for which, independently of the physical infrastructure available to access the communication network (Internet), different quality of service levels are offered to customers depending on the contract they take out. These are, for example, 4^{th} or later generation cellular radio access networks or IP/xDSL or IP/PON broadband access networks.

According to one aspect of the present disclosure, the item of activation information of a second quality of service level comprises an item of identification information of a source of the data packet and an item of identification information of a destination of the data packet.

One advantage is that the item of activation information is an item of information comprised in an information field that is already present in the data stream. The detection of this pair of addresses is sufficient to trigger the verification in the data table that the received data packet is to be processed according to the second quality of service level. One advantage is that there is no need to add the additional item of information to the data stream.

According to another aspect of the present disclosure, the item of activation information of a second quality of service level comprises a connection token.

Advantageously, the connection token is obtained specifically for the communication between the item of client equipment and the item of server equipment, which offers an increased level of security and also greater flexibility. It is inserted into each data packet sent by the item of server equipment or by the item of client equipment and its detection allows the item of routing equipment of the first communication network to process the data packet with the QoS specifications (second quality of service level) determined by the item of server equipment for the client equipment communicating with it, depending on the specific subscription it has taken out with its Internet access provider.

In addition, it can advantageously be associated with a validity period in the data table, which facilitates the verification of the rights by the item of control equipment of the access network. Another advantage is that it allows a quality of service level to be specified for the data streams exchanged between the item of client equipment and the item of server equipment, regardless of the destination address of the data stream. It therefore offers greater flexibility and is particularly well suited to the case of a VPN connection of an employee’s item of client equipment to their employer’s item of server equipment.

According to yet another aspect of the present disclosure, said quality of service management rule comprises an item of information relating to a type of service and the application of said rule comprises inserting said item of information into a header of the data packet.

An exemplary embodiment of the present disclosure thus defines an additional type or class of service intended to be directly used by other router equipment of other networks through which the data packet travels and managed by other operators. The advantage of such a standardised class of service is that it is shared and known by all networks, as are the processing conditions to apply to the data packet carrying it.

Advantageously, in a DiffServ network architecture, implementing a quality of service management based on different classes of services, the item of type of service information is inserted into the information field ToS of an IP data packet and it is detected and exploited by the routing equipment of the communication network to process the data packet according to the conditions specified by the detected item of type of service information. This is an existing protocol infrastructure, so there is no need to change the operation of the router equipment. According to yet another aspect of the present disclosure, the method comprises obtaining an item of count information of a quantity of resources allocated for routing said stream in application of the second quality of service level and recording said item of information.

One advantage is that the network access provider of the user of the item of server equipment can be charged for the network resources used to apply the second quality of service level (number of connections, volume of data per connection and per management entity of the (item of) server equipment, etc.). For example, the additional resources used in comparison with a conventional quality of service management are evaluated. Advantageously, the count information is transmitted to a quality of service management entity dedicated to the management of facilitated connections according to an exemplary embodiment, which is responsible for collecting it from the different routing equipment involved and for implementing the billing policy of the access network of the item of server equipment.

An exemplary embodiment of the present disclosure thus proposes a new telecommunications service based on the principle of the disclosure and an inter-operator billing policy for communication networks. Agreements between access providers, such as those that exist to manage user mobility (roaming agreements), could make the implementation of such a service easier.

An exemplary embodiment of the present disclosure also relates to a device for processing a data packet exchanged between an item of client terminal equipment and an item of server equipment via a communication network, which the item of client equipment accesses via a first communication network, a first quality of service level being intended to be applied to said data packet in the first network, said device being configured to implement at an item of routing equipment of said first communication network:
detecting in said data packet at least one item of activation information of a second quality of service level, said second quality of service level being applicable to data packets exchanged with said item of server equipment;
obtaining a quality of service management rule according to the second quality of service level, associated with said item of activation information; and
applying the second quality of service level to the routing of said data packet according to the obtained rule, instead of the first quality of service level.

Advantageously, said device is configured to implement the steps of the processing method as described above.

Advantageously, said device is integrated into an item of routing equipment of the communication network.

Advantageously, said item of routing equipment is comprised in a system for managing the quality of service applied to data packets exchanged between an item of client equipment and an item of server equipment in a communication network, which said item of client equipment accesses via a first communication network. The system, the item of routing equipment and the processing device have at least the same advantages as those conferred by the above-mentioned processing method.

Correlatively, an exemplary embodiment of the present disclosure also relates to a method for processing a request to change the quality of service level of a connection of an item of client equipment to an item of server equipment in a communication network which the item of client equipment accesses via a first communication network, a first quality of service level being applied by the first communication network to data packets exchanged in said connection, said request being received by the item of server equipment.

Said method is implemented by the item of server equipment and comprises, upon receipt of said request to change the quality of service:
deciding whether or not to accept the received request to change the quality of service level;
when it has been decided to accept the request to change the quality of service, recording in a data table, known as the connection management table, accessible from the communication network, at least one item of activation information of a second quality of service level applicable to the routing of the data packets exchanged between said item of client equipment and said item of server equipment;
transmitting a response to the item of client equipment.

The request to change the quality of service level may be implicit or explicit. With an exemplary embodiment of the present disclosure, the item of server equipment decides whether or not to accept the item of client equipment’s request to access the second quality of service level to communicate with it. For example, it makes this decision based on a number of current connections to other client equipment and a maximum number of simultaneous connections allowed. When its decision is positive, it declares an item of activation information of this second quality of service level for the connection with the item of client equipment in a data table accessible from the communication network, so that the communication network can access this item of information and apply the quality of service management rule(s) specific to this second quality of service level. This data table includes entries associating this item of activation information of a second quality of service level with an item of identification information of the item of server equipment.

It is noted that the request to change the quality of service level can be transmitted to the item of server equipment in different ways. For example, the item of client equipment connects to the item of server equipment and displays a web page from that item of server equipment on screen of the item of client equipment. The user then clicks a button to trigger the transmission of the request to change the quality of service level.

According to another aspect of the present disclosure, the method further comprises:
obtaining a connection token,
recording said connection token as an item of activation information of the second quality of service level in the data table in association with said item of identification information of the item of server equipment; and
the response to the item of client equipment comprises said connection token.

One advantage of the connection token is that it makes it easy to identify the connection to be updated. It can advantageously be specifically calculated for each new accepted request. It is for example a hash code whose calculation can advantageously involve identification and/or temporal and spatial location information for the item of client equipment. It is sent to the item of client equipment so that it can update its connection to the item of network control equipment and then label the data packets transmitted to the data stream.

An exemplary embodiment of the present disclosure also relates to a device for processing a request to change the quality of service level of a connection of an item of client equipment to an item of server equipment in a communication network which the item of client equipment accesses via a first communication network, a first quality of service level being applied by the first communication network to data packets exchanged in said connection, said request being received by an item of server equipment from an item of client equipment. Said device is configured to implement at the item of server equipment:
deciding whether or not to accept the received request to change the quality of service level;
when it has been decided to accept the received request to change the quality of service level, recording in a data table, known as the connection management table, at least one item of validation information of a second quality of service level applicable to the routing of the streams exchanged regarding a communication between said item of client equipment and said item of server equipment.

Advantageously, said device is configured to implement the steps of the method for processing a change request as described above.

Advantageously, said device is integrated into the item of server equipment.

Advantageously, said item of server equipment is comprised in a system for managing the quality of service applied to data packets exchanged between an item of client equipment and an item of server equipment in a communication network, which said item of client equipment accesses via a first communication network. The system, the item of server equipment and the device for processing a change request have at least the same advantages as those conferred by the above-mentioned method for processing a change request.

Correlatively, the present disclosure also relates to a method for requesting to change a quality of service level of a connection of an item of client equipment to an item of server equipment in a communication network which the item of client equipment accesses via a first communication network, a first quality of service level being applied by the first communication network to data packets exchanged in said connection. Said method comprises:
receiving a response from the item of server equipment, said response comprising an item of activation information of a second quality of service level, said second quality of service level being applicable to the data packets exchanged between the item of client equipment and the item of server equipment;
transmitting a request to update the connection to an item of control equipment of said communication network, said update request comprising said item of activation information of a second quality of service level;
inserting the item of activation information of a second quality of service level into a data packet and transmitting said data packet in the first communication network.

According to an exemplary embodiment of the present disclosure, the item of client equipment requests the second priority level to be obtained from the item of server equipment. In case of a positive response, it obtains an item of activation information of this second level of priority, which it sends to an item of quality of service management equipment of the first communication network to update its connection to the communication network. In this way, the data streams exchanged with the item of server equipment will be processed with the second level of priority, instead of the first level of priority to which its usual connection entitles it.

An exemplary embodiment of the present disclosure also relates to a device for requesting to change a quality of service level of a connection of an item of client equipment to an item of server equipment in a communication network which the item of client equipment accesses via a first communication network, a first quality of service level being applied by the first communication network to data packets exchanged in said connection, said device being configured to implement the item of client equipment:
receiving a response from the item of server equipment, said response comprising an item of activation information of a second quality of service level, said second quality of service level being applicable to the data packets exchanged between the item of client equipment and the item of server equipment;
transmitting a request to update the connection to an item of control equipment of said communication network, said update request comprising said item of activation information of a second quality of service level;
inserting the item of activation information of a second quality of service level into a data packet and transmitting said data packet in the first communication network.

Advantageously, said device is configured to implement the steps of the change request method as described above.

Advantageously, said device is integrated into the item of client equipment.

Advantageously, said item of client equipment is comprised in a system for managing the quality of service applied to data packets exchanged between an item of client equipment and an item of server equipment in a communication network, which said item of client equipment accesses via a first communication network. The system, the item of client equipment and the change request device have at least the same advantages as those conferred by the above-mentioned change request method.

Correlatively, the present disclosure also relates to a method for managing a quality of service of a connection of an item of client equipment to an item of server equipment in a communication network which the item of client equipment accesses via a first communication network, a first quality of service level being applied by the first communication network to data packets exchanged in said connection. Said method is advantageously implemented by a quality of service management entity of the first network and comprises:
receiving from the item of client equipment a request to update said connection for routing data packets exchanged between said item of client equipment and said item of server equipment;
detecting an item of activation information of the second quality of service level in said update request;
verifying a validity of the item of activation information by querying a data table, known as the connection management table, at least from said item of activation information and an item of identification information of the item of server equipment; and
installing a quality of service management rule according to the second quality of service level associated with said item of activation information of the second quality of service level for said connection and
transmitting a response to the item of client equipment.

The connection of the item of terminal equipment to the communication network is thus updated by installing a new quality of service management rule, so that the second quality of service level is triggered instead of the first quality of service level for the data packets exchanged between the item of client equipment and the item of server equipment. One advantage of an exemplary embodiment of the present disclosure is that it allows the management of two distinct quality of service levels to coexist within the same access of an item of client equipment to the communication network, the first one corresponding to the quality of service level provided for by the contract taken out by the item of client equipment (the source) to access the communication network, and the second one being specific to a connection with a particular item of server equipment, and defined by a specific contract taken out by this item of server equipment (the destination) with an operator to manage the access of its clients.

This new quality of service management rule is installed only after the validity of the item of activation information received from the item of client equipment has been verified. Advantageously, the connection management data table is queried using the item of activation information and an item of information from the item of server equipment.

Advantageously, the response obtained includes an item of validity information associated with the item of activation information. For example, the item of validity information is an item of binary information, which is 0 when the item of activation information is not valid and 1 when it is valid. Advantageously, it also comprises an item of validity period information, for example equal to one hour. In this way, the quality of service management entity can define a validity period of the quality of service management rule aligned with this period.

Advantageously, the response further comprises the quality of service management rule to be applied to the current data packet.

An exemplary embodiment of the present disclosure also relates to a device for managing a quality of service of a connection of an item of client equipment to an item of server equipment in a communication network which the item of client equipment accesses via a first communication network, a first quality of service level being applied by the first communication network to data packets exchanged in said connection. Advantageously, said device is configured to implement at a quality of service management entity of the first network:
receiving from the item of client equipment a request to update said connection for routing data packets exchanged between said item of client equipment and said item of server equipment;
detecting an item of activation information of the second quality of service level in said update request;
verifying a validity of the item of activation information by querying a data table, known as the connection management table, at least from said item of activation information and an item of identification information of the item of server equipment; and
when it has been verified that the item of activation information is valid, recording the item of activation information in a memory in association with the item of identification information of the item of server equipment and an item of identification of the item of client equipment;
installing a quality of service management rule associated with the second quality of service level for said connection and
transmitting a response to the item of client equipment.

Advantageously, said device is configured to implement the steps of the management method as described above.

Advantageously, said device is integrated into the quality of service management entity.

Advantageously, the quality of service management entity is integrated into the above-mentioned system. The system, the management entity and the management device have at least the same advantages as those conferred by the above-mentioned management method.

An exemplary embodiment of the present disclosure also relates to computer program products comprising program code instructions for the respective implementation of the methods for processing a data packet, for processing a request to change a quality of service level, for requesting to change a quality of service level and for managing a quality of service as described previously, when executed by a processor.

A program can use any programming language, and can be in the form of source code, object code, or intermediate code between source code and object code, such as in a partially compiled form, or in any other desirable form.

An exemplary embodiment of the present disclosure also relates to at least one computer-readable storage medium on which are saved computer programs comprising program code instructions for implementing the steps of the methods according to the present disclosure as described above.

Such a storage medium can be any entity or device able to store the program. For example, the medium can comprise a storage means, such as a ROM, for example a CD-ROM or a microelectronic circuit ROM, or a magnetic recording means, for example a mobile medium (memory card) or a hard disk or SSD.

On the other hand, such a storage medium can be a transmissible medium such as an electrical or optical signal, that can be carried via an electrical or optical cable, by radio or by other means, so that the computer program contained therein can be executed remotely. The programs according to exemplary embodiments of the present disclosure can be downloaded in particular on a network, for example the Internet network.

Alternatively, the storage medium or media can be one or more integrated circuits in which the program is embedded, the circuit(s) being adapted to execute or to be used in the execution of the above-mentioned method(s).

According to an embodiment, the present technique is implemented using software and/or hardware components. In this context, the term “module” may be used in this document to refer to a software component, a hardware component or a combination of hardware and software components.

A software component is one or more computer programs, one or more subroutines of a program, or more generally any element of a program or software capable of implementing a function or set of functions, as described below for the module concerned. Such a software component is executed by a data processor of a physical entity (terminal, server, gateway, set-top-box, router, etc.) and is able to access the hardware resources of this physical entity (memories, recording media, communication buses, electronic input/output cards, user interfaces, etc.). Hereafter, resources are understood to be any set of hardware and/or software elements that support a function or service, whether individually or in combination.

In the same way, a hardware component is any element of a hardware assembly capable of implementing a function or set of functions, as described below for the module concerned. It may be a programmable hardware component or a component with an embedded processor for executing software, for example, an integrated circuit, a smart card, a memory card, an electronic card for executing firmware, etc.

Each component of the system described above naturally implements its own software modules. The various embodiments mentioned above can be combined with each other for the implementation of the present technique.

### 4. BRIEF DESCRIPTION OF THE FIGURES

Other purposes, features and advantages of the present disclosure will become more apparent upon reading the following description, hereby given to serve as an illustrative and non-restrictive example, in relation to the figures, among which:

FIG. 1 diagrammatically shows a connection established between an item of client equipment and an item of server equipment in a communication network, according to an embodiment of the present disclosure;

FIG. 1A diagrammatically shows an example of the architecture of a first communication network through which the item of client equipment accesses the communication network and connects to the item of server equipment according to an embodiment of the present disclosure;

FIG. 2 diagrammatically shows an example of the architecture of a connection management system of such an item of terminal equipment according to an embodiment of the present disclosure;

FIG. 3 describes in the form of a flowchart the steps of a method for requesting to change a quality of service level of a connection of an item of client equipment to a communication network according to an embodiment of the present disclosure;

FIG. 4 describes in the form of a flowchart the steps of aa method for processing a request to change a quality of service level of a connection of an item of client equipment to a communication network according to an embodiment of the present disclosure;

FIG. 5 describes in the form of a flowchart the steps of a method for processing a data packet exchanged by the item of client equipment and the item of server equipment according to an embodiment of the present disclosure;

FIG. 5A diagrammatically shows an example of the structure of a header of an IP data packet according to an embodiment of the present disclosure;

FIG. 6 describes in the form of a flowchart the steps of a method for managing a quality of service of a connection between the item of client equipment and the item of server equipment according to an embodiment of the present disclosure;

FIG. 7 diagrammatically shows the messages exchanged between the item of server equipment, the item of client equipment and the communication network according to an embodiment of the present disclosure;

FIG. 8 diagrammatically shows an example of the hardware structure of a device for processing a data stream according to an embodiment of the present disclosure;

FIG. 9 diagrammatically shows an example of the hardware structure of a device for processing a request to change a quality of service level of a connection according to an embodiment of the present disclosure;

FIG. 10 diagrammatically shows an example of the hardware structure of a device for requesting to change a quality of service level of a connection according to an embodiment of the present disclosure; and

FIG. 11 diagrammatically shows an example of the hardware structure of a device for managing a quality of service of a connection between the item of client equipment and the item of server equipment according to an embodiment of the present disclosure.

### 5. DETAILED DESCRIPTION OF ILLUSTRATIVE EMBODIMENTS

An exemplary embodiment of the present disclosure relates to a communication network which an item of client equipment accesses via a first communication network under the terms of a contract taken out by the user of the item of client equipment with an operator of that first network. This item of client equipment wants to connect to a remote item of server equipment through this access. The contract taken out by the user defines a first quality of service level to be applied to a data stream that the item of client equipment will have to exchange with other terminal equipment regarding application connections, and in particular regarding the one it establishes with the item of server equipment. For example, this first quality of service level defines a maximum data rate that the item of client equipment should benefit from at least at a first hop that would take it outside the first access network operated by its access provider.

The general principle of an exemplary embodiment of the present disclosure is based on the insertion of an item of activation information of a second quality of service level into the data packets exchanged with the item of server equipment and on the recognition of this item of information by an item of routing equipment of the first communication network to route these data packets by applying to them the second quality of service level, defined by a second contract taken out by the user of the item of server equipment, instead of the first quality of service level. The implementation of this facilitated connection mechanism further comprises a prior update of the connection of the item of client equipment, for example by a quality of service management entity of the first communication network. It is based on a prior verification of the validity of the item of activation information inserted into the item of equipment’s request to a data table, known as the connection management table, accessible from the communication network, and comprises the installation of a quality of service management rule corresponding to the second quality of service level.

An exemplary embodiment of the present disclosure therefore allows specific quality of service conditions to be applied to data exchanges between an item of server equipment and an item of client equipment in the communication network, instead of those defined by contract for the item of client equipment’s access to the communication network.

In the following, a communication network is generically defined as an Internet-type communication network that can be accessed by the item of terminal equipment via one or more access networks to that network, and it is considered that this communication network and its access networks are IP-based, that is that any type of traffic, for example, voice, SMS, data, is treated as IP data packet traffic.

An exemplary embodiment of the present disclosure applies to any type of item of terminal equipment, fixed or mobile, comprising at least one interface for communication with a communication network. This interface can be wired, such as an ADSL or fibre interface, or non-wired, such as a cellular radio, WLAN, Bluetooth, Zigbee, or other interface.

In the following description, item of terminal equipment (or sometimes simply “terminal”) is any entity capable of establishing or accepting the establishment of a communication based on the use of one or more transport protocols, such as TCP, UDP or QUIC, for example. It can be a physical entity, a virtual entity, or a software application embedded in the item of terminal equipment.

The item of terminal equipment that initiates the establishment of a communication is generally referred to as the sending terminal or the item of client equipment, while the one to which the establishment request is addressed is called the remote terminal or the item of server equipment. A single terminal can therefore act as both client and server.

In the following, quality of service or QoS refers to any technology implemented by a communication network to manage the transmission of data while reducing packet loss, jitter and latency. Such technology controls the allocation of network resources and manages in particular the bandwidth, or the maximum capacity for transmitting a volume of data from one point to another during a given period, by prioritising different applications or different types of data among themselves, these applications or types of data being associated with different quality of service levels. Quality of service management is based on quantitative measurements of performance parameters.

QoS is integrated into the contracts taken out by the users of terminal equipment who want to benefit from an access to the Internet network in the form of a Service Licence Agreement or SLA, which ensures a given level of performance for a given service.

In the following, network resources are both hardware and software resources in the core network or in an access network, for example, a network of mobile radio access (RAN) to the communication network.

This notion of resource includes the item of access equipment, such as a data modulation module, a time slot allocation module for data transmission, a module for managing the quality of service associated with the different types of data transmitted (voice, loT, video, etc.). For a base station of a cellular access network, this involves for example particular components of this radio antenna, such as PRB (Physical Resource Block) resource units, modulation modules, time slot allocation modules for data transmission, QoS (Quality of Service) management modules for the different types of data transmitted, etc. The availability of these resources is assessed from data traffic information relating to a bandwidth, a data rate, a data volume, a number of physical resource blocks or PRBs, etc., already allocated or available, at an item of mobile access equipment such as a base station or an item of node equipment of a core network user plane.

An exemplary embodiment of the present disclosure has a particularly interesting application when the physical infrastructure of the first communication network the item of terminal equipment accesses technically allows it to access a high quality of service level, in terms of maximum data rate, for example in the order of Gbit/sec (for an optical fibre access) or 150 Mbits/s (for a cellular radio access), but the quality of service level it has taken out with its access provider only entitles it to a quality of service level lower than this maximum rate (for example 300 Mbits/s for a first level of fibre optic subscription or 128 kbits/s for a reduced rate once the monthly mobile data volume has been consumed). This situation typically arises in the case of a mobile communication network. The user of the item of terminal equipment may be located in a radio coverage area that technically gives them access to a high quality of service level, via a 4G or 5G connection for example, while their subscription actually corresponds to a low quality of service level (low or zero monthly data volume, for example).

This is also the case with a fixed communication network and an IP/xDSL or IP/PON access technology available with different subscriptions associated with different data rates.

In the following, embodiments of the present disclosure in a mobile telecommunication network, whose architecture complies with the 3GPP standard (in one of its current or future versions) and implements radio access equipment of the base station type, and in a fixed communication network implementing an IP/xDSL (Digital Subscriber Line) or IP/PON (Passive Optical Network) high-speed collection architecture is described in more detail. Of course, and as already mentioned, the invention is not limited to the examples described and is equally applicable to other types of fixed or mobile telecommunication networks and other wireless or wired access technologies. Consequently, the access equipment to which the item of client terminal equipment attaches in order to connect to the communication network comprises, in a non-restrictive manner, a base station, a femtocell associated with that base station, an item of DSLAM (Digital Subscriber Line Access Multiplexer) equipment for an ADSL-type access network, a Wi-Fi hotspot or a Wi-Fi repeater associated with that hotspot, an item of ONT (Optical Network Termination) equipment for a PON (Passive Optical Network) type fibre access network, etc.

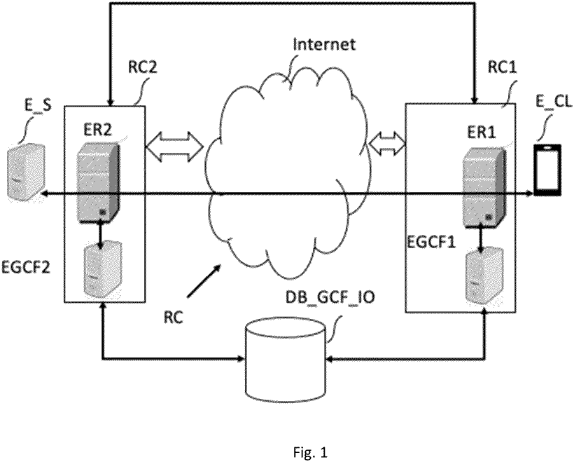

In relation to FIG. 1, a simplified example of the architecture of a communication network RC, for example of the Internet type, in which an exemplary embodiment of the present disclosure lies, is presented by way of illustration. An item of client terminal equipment E_CL is considered, such as a smartphone, a PC or a tablet, accessing the communication network RC via a first access network RC1 operated by a first access provider. For this purpose, the user of this item of client terminal equipment has taken out with this first access provider a subscription that allows them to connect to the first access network RC1 with a first quality of service level QoS1. For example, the user has taken out a 4G mobile plan with a monthly data volume of 50 GB and a maximum data rate of 150 Mbit/s. Beyond the monthly volume, the data rate is reduced to 128 kbps until the end of the current billing period. In particular, it is assumed that this item of terminal equipment E_CL uses this access to the network RC to establish a communication with another item of terminal equipment, for example the remote item of server equipment E_S. It is assumed that the latter accesses the communication network RC via a second access network RC2 of a second access provider. In the following, it is assumed that the user or the entity managing the item of server equipment E_S has taken out a subscription with this second access provider with a quality of service level QoS2 higher than the first quality of service level QoS1 level the item of terminal equipment E_CL benefits from. According to n exemplary embodiment of the present disclosure , this subscription is particular in that it defines the possibility to allow a given number of client equipment requesting to establish a communication with the item of server equipment E_S via the communication network to benefit from a second given quality of service level for this communication. The item of server equipment E_S is, for example, a computer with several communication interfaces allowing it to establish several simultaneous communications with different client equipment. Its user is, for example, a professional, such as a company managing a commercial site, or a telemedicine platform, or a distance learning platform, etc.

According to an exemplary embodiment of the present disclosure, the item of server equipment E_S can decide to validate this second service level for an item of client equipment E_CL that connects to it, upon request of the latter or on its own initiative. For this purpose, it must validate or activate the second quality of service level for this item of client equipment with a quality of service management entity EGCF2 of the second network RC2. Advantageously, it updates a dedicated data table DB_GCF_IO, known as the facilitated connection management table, accessible from the communication network RC to the first network RC1 and to the second network RC2. It is noted that the recording of the item of activation information of the second quality of service level in the data table DB_GCF_IO can alternatively be implemented directly by the item of server equipment E_S itself or by a first item of router equipment ER2 of the second access network RC2, which is natively configured to control the traffic transmitted or received by the item of server equipment E_S and to apply to it the quality of service management policy defined by contract with the access provider of the second network.

On the first network RC1 side, the activation of the second quality of service level QoS2 for the item of client equipment requires an update of the quality of service management rules associated with the connection of the item of terminal equipment E_CL to the first access network RC1. According to an exemplary embodiment of the present disclosure, this update is implemented by a quality of service management entity EGCF1 of the first access network configured to access the data table DB_GCF_IO and to verify by this means that the item of client equipment benefits from this update and to configure it with a first item of routing equipment ER1 of the first network RC1, natively configured to control the traffic from and to the item of client equipment E_CL and to apply the appropriate quality of service management policy.

FIG. 1A diagrammatically shows an example of a first communication network RC1 whose architecture is of the IP/xDSL type. The item of client equipment E_CL, for example, a smartphone, a TV decoder or STB (Set Top-Box) or a PC (Personal Computer), is connected to an item of equipment for accessing the network RC1, for example, a home gateway HG. The item of client equipment E_CL and the item of access equipment HG thus form an item of CPE (Customer Premise Equipment) equipment that is connected to a first item of DSLAM equipment of the network RC1. The item of routing equipment ER1, which in this example is a BNG (Broadband Network Gateway) gateway, is considered in particular. This item of equipment is natively configured to control and filter incoming and outgoing data traffic for the item of client equipment E_CL.

According to this example of architecture, a network operations centre NOC is also considered, which typically includes equipment such as a Radius authentication server and a DHCP server. According to this embodiment of the present disclosure, it further comprises the quality of service management entity EGCF1 configured to manage the connections that benefit from an update of their quality of service according to the principle of the present disclosure (“facilitated connection”). Advantageously, the centre NOC also has a memory comprising a data table DB_GCF1 in which information relating to the application connections that benefit from this update is stored. This is advantageously a local copy of information obtained from the inter-operator data table DB_GCF_IO according to the present disclosure.

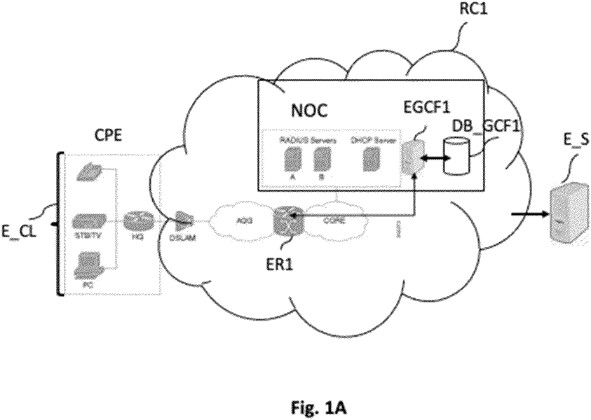

FIG. 2 diagrammatically shows an example of the architecture of a system S for managing the quality of service to be applied to data packets exchanged between an item of client equipment and an item of server equipment via a telecommunication network, according to an embodiment of the present disclosure, for example in the environment of FIG. 1 and/or FIG. 1A.

According to this embodiment of the present disclosure, the system S comprises the item of client terminal equipment E_CL, the item of server equipment E_S, the item of routing equipment ER1 of the first access network RC1 configured to control the data traffic between the item of client equipment E_CL and the first network RC1, the management entity EGCF1 and the connection management table DB_GCF_IO. It is assumed that the item of terminal equipment E_CL accesses the communication network RC via the first access network RC1 with a first quality of service level and wants to connect to the item of server equipment via the communication network RC. According to this embodiment of the present disclosure, the item of client equipment E_CL comprises a device 300 for requesting to update a connection, configured to request an update of its application connection to the item of server equipment, obtain, from the item of server equipment, a response comprising an item of activation information of a second quality of service level, said second quality of service level being applicable to the data packets exchanged between the item of client equipment and the item of server equipment, transmit a connection update request to the item of quality of service management equipment EGCF1 of the first communication network, said update request comprising said second item of activation information of a second quality of service level and receive a positive or negative response.

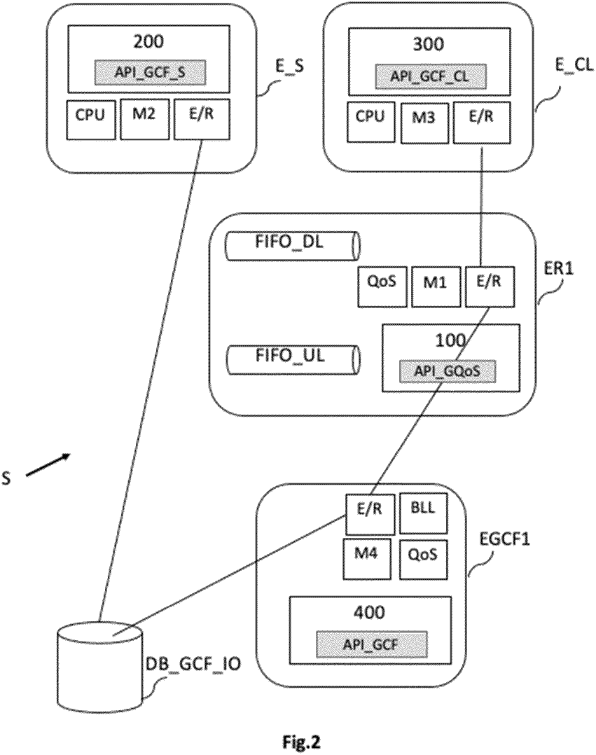

The device 300 thus implements the method for requesting to update a connection that will be detailed hereafter in relation to FIG. 3.

According to an embodiment, it is implemented in the form of an API (Application Programming Interface) software application API_GCF_CL, installed on the item of client equipment E_CL. Advantageously, this application is dedicated to the implementation of a communication with the item of server equipment E_S.

Advantageously, the item of terminal equipment E_CL has the hardware structure of a computer and comprises a processor CPU, a memory M3 in which computer programs are stored, for example, as well as a transmission/reception module E/R which allows it to communicate via at least one interface with the first communication network RC1 with other terminal equipment, such as the item of server equipment E_S.

Alternatively, the device 300 may be independent of the item of terminal equipment E_CL, but connected to it by any link whatsoever, wired or not. For example, it may be embedded in any CPE (Customer Premise Equipment) item of equipment for accessing a communication network, such as a home gateway, through which the item of client equipment E_CL connects to the access network RC1.

In this embodiment, the quality of service level management entity EGCF1 comprises a device 400 for updating a connection, configured to receive from the item of client equipment a request to update said connection for routing data packets exchanged between said item of client equipment and said item of server equipment, detect an item of activation information of the second quality of service level in said update request, verify a validity of the item of activation information by querying a data table, known as the connection management table DB_GCF_IO, at least from said item of activation information and an item of identification information of the item of server equipment, record the item of activation information in a memory in association with the item of identification information of the item of server equipment and an item of identification information of the item of client equipment, install a quality of service management rule associated with a second quality of service level for said connection and transmit a response to the item of client equipment.

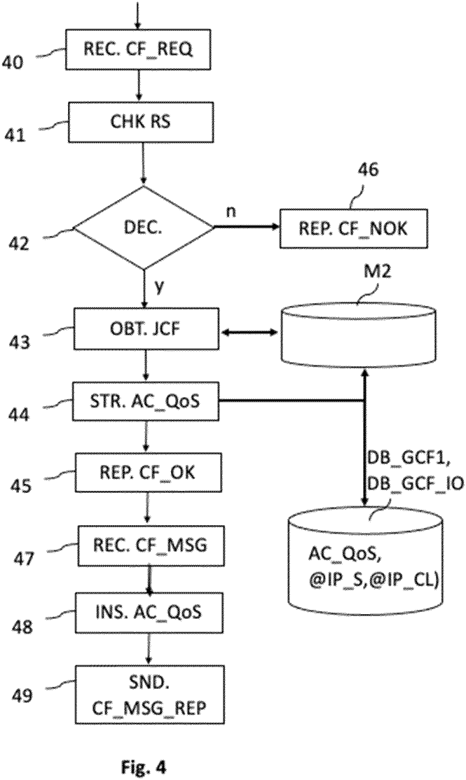

The device 400 thus implements the method for updating a connection that will be detailed hereafter in relation to FIG. 5.

According to an embodiment, the device 400 is implemented in the form of an API software application API_GCF, installed on the entity EGCF1. Advantageously, this application is dedicated to the update of a connection of the item of terminal equipment E_CL with the item of server equipment E_S.

The quality of service management entity EGCF1 can be instantiated as a dedicated or not item of physical equipment or as virtualised entities.

Advantageously, the quality of service management entity EGCF1 has the hardware structure of a computer and comprises a processor CPU, a memory M4 in which computer programs are stored, for example, as well as a transmission/reception module E/R which allows it to communicate via at least one interface with other equipment, such as the item of routing equipment ER1, and to query the remote data table DB_GCF_IO. Advantageously, it comprises a billing management module BILL.

Advantageously, it stores in its memory M4 a copy of the information received from the data table DB_GCF_IO, such as, for example, the item of activation information of the second quality of service level associated with an item of identification information of the item of server equipment, an item of identification information of the item of client equipment and an item of validity information (for example a validity period). It can also store the quality of service management rule to be applied to the data packets carrying the item of activation information.

In a fixed network architecture, this entity EGCF1 can advantageously be integrated into the network operations centre NOC already described in relation to FIG. 1A.

In this embodiment of the present disclosure, the item of routing equipment ER1 comprises a device 100 for processing a data packet exchanged between the item of client terminal equipment and the item of server equipment via the communication network, configured to detect in said data packet at least one item of activation information of a second quality of service level, said second quality of service level to be applied to said data packet, obtain a quality of service management rule associated with said item of activation information; and apply said rule to the routing of said data packet between the item of client equipment and the item of server equipment.

The device 100 thus implements the method for processing a data packet that will be detailed hereafter in relation to FIG. 5.

According to an embodiment, the device 100 it is implemented in the form of an API software application API_GQoS, installed on the item of routing equipment ER1. Advantageously, this application is dedicated to the update of a connection of the item of terminal equipment E_CL with the item of server equipment E_S.

The item of routing equipment ER1 may be instantiated as an item of physical equipment dedicated or not to the respective functions of this item of control equipment, or as virtualised entities.

In a fixed IP/xDSL or IP/PON network, it is, for example, a BNG gateway as illustrated in FIG. 1A. In a mobile radio access network, it may also be an item of equipment such as an APN (Access Point Name) server to which a mobile connects to access the Internet.

Advantageously, the item of routing equipment ER1 has the hardware structure of a computer and comprises a processor CPU, a memory M1 in which computer programs are stored, for example, as well as a transmission/reception module E/R which allows it to communicate with other equipment of the network and with the item of client equipment E_CL. Advantageously, it also comprises a quality of service management module QoS configured to apply a given quality of service management policy. Finally, it comprises a first queue FIFO_UP configured to store the data packets transmitted by the item of client equipment E_CL temporarily in the first communication network RC1 and a second queue FIFO_DL configured to store, temporarily, data packets destined for the item of client equipment and coming from the first network RC1. In a known manner, the item of routing equipment ER1 is in particular configured to accelerate or delay the output of the data packets of the first and second queues FIFO_UL, FIFO_DL in order to comply with the given quality of service management policy.

Alternatively, the device 100 may be independent of the item of routing equipment ER1, but connected to it by any link whatsoever, wired or not. For example, it may be integrated into another item of equipment of the access network RC1, such as an item of radio access equipment, like a base station BS for a cellular radio access network, for example. It is noted that according to the 5G architecture, a base station, called gNodeB, is composed of several elements, among which are found a central unit CU, a distributed unit DU, and a remote unit or RU. These elements are potentially hosted in distinct network equipment. The device 100 according to an embodiment of the present disclosure may be embedded into one of these three units, preferably in the CU unit.

In the embodiment of the present disclosure of FIG. 2, the item of server equipment E_S comprises a device 200 for processing a request to change the quality of service level received from the item of client equipment E_CL via the communication network RC, configured to decide whether or not to accept the received request to change the quality of service level, when it has been decided to accept the received request to change the quality of service level and record in the connection management data table DB_GCF_IO at least one item of activation information of a second quality of service level applicable to the routing of the data packets exchanged between said item of client equipment and said item of server equipment.

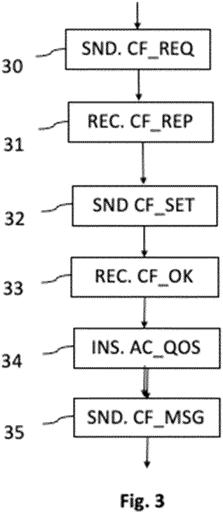

The device 100 thus implements the method for processing a request to update the connection that will be detailed hereafter in relation to FIG. 4.

According to an embodiment, it is implemented in the form of an API software application API_GCF_S, installed on the item of server equipment E_S. Advantageously, this application is dedicated to the processing of a request to update the connections of terminal equipment such as the item of terminal equipment E_CL with the item of server equipment E_S.

Advantageously, the item of terminal server equipment E_S has the hardware structure of a computer and comprises a processor CPU, a memory M2 in which computer programs are stored, for example, as well as a transmission/reception module E/R which allows it to communicate via at least one interface with the communication network RC with other terminal equipment, such as the item of client equipment E_CL as well as with equipment of the network RC such as the data table DB_GCF_IO.

Alternatively, the device 200 may be independent of the item of server equipment E_S, but connected to it by any link whatsoever, wired or not. For example, it may be embedded into any CPE item of access equipment, such as a home or professional gateway, through which the item of server equipment E_S connects to the access network RC2.

In relation to FIG. 3, an embodiment of a method for requesting to update a connection of the item of client terminal equipment E_CL with the item of server equipment E_S via the communication network RC is now presented in the form of a flowchart. Application connection is understood here as any exchange of data packets between the item of client equipment and the item of server equipment, implementing or not a communication session between these two items of equipment.

It is assumed that the item of terminal equipment E_CL accesses the communication network RC via the first access network RC1, which applies a first quality of service level QoS1 to the data packets the item of client equipment exchanges with that item of server equipment. In the following, this method is implemented by the above-mentioned device 100, for example integrated into the item of client terminal equipment E_CL.

In 30, a request CF_REQ to change the quality of service level is transmitted to the item of server equipment E_S via the communication network RC.

It is noted that this request may be explicit or implicit. In the first case, a specific message is sent to the item of server equipment E_S or a particular information field of a request to establish a communication with the item of server equipment is set to a given value, intended to be interpreted by the item of server equipment as a request to change the quality of service level. Advantageously, the device 100 can decide beforehand whether this update request is necessary using the first quality of service level QoS1 to which the item of client equipment is entitled as a result of its subscription, for example by comparing this first quality of service level with a given threshold. For example, it considers that below this threshold, the communication with the item of server equipment will not be able to take place under satisfactory conditions and the service offered by the item of server equipment will not be able to be provided correctly. In this situation, it decides to transmit a request to change the quality of service level to the item of server equipment E_S, otherwise, when the given threshold is reached or exceeded, it considers that such a request is unnecessary.

In the second (implicit) case, it is for example the simple fact of sending a request to establish a communication with the item of server equipment E_S that is considered as a request to change the quality of service level and that will be interpreted as such by the item of server equipment E_S. The request is therefore also systematic.

As a variant, the item of server equipment E_S may also decide on its own initiative that it will provide the item of client equipment E_CL with the second quality of service level following the connection request of the item of client equipment E_CL. Advantageously, the item of server equipment makes this decision on the basis of a given criterion, such as a one-off need for an increased level of resources. For example, it plans to transmit a large data file to this item of client equipment and implements a quality of service level change for this item of client equipment E_CL so that this transmission takes place under good conditions.

In 31, a response CF_REP is received from the item of server equipment E_S. Advantageously, this response comprises an item of activation information AC_QoS of a second quality of service level, said second quality of service level QoS2 being intended to be applied to the data packets exchanged between the item of client equipment and the item of server equipment. This is, for example, an item of identification information of the connection, comprising at least one pair of IP addresses of the item of client equipment and the item of server equipment (@IP_CL, @IP_S). This item of information may further comprise a source port number. Indeed, the port number specifies a particular service, an application or a machine of a subnetwork of the item of client equipment. The activation of the connection update can be specific to a port number of the item of client equipment.

According to a particular embodiment, this item of activation information comprises a connection token JCF, for example generated by the item of server equipment E_S. Since it is shared only by the item of server and the item of client equipment, it offers an increased level of security.

It is noted that this response CF_REP is not necessarily received by the item of client equipment E_CL on the same interface as that used to request to establish the connection and, if applicable, request to change the quality of service level. Advantageously, it can be received on another communication interface of the item of client equipment E_CL with the communication network RC. For example, when the item of client equipment E_CL is a mobile terminal equipped with a cellular radio communication interface and a SIM (Subscriber Identification Mobile) card associated with a telephone number, the response CF_REP may be received in a short message such as an SMS (Short Messaging System) or via a voice message or an e-mail sent to an e-mail address of the user of the item of client equipment E_CL. Yet another option is for the user to validate an option offered on a web page (for example, by clicking an icon) sent by the item of server equipment, this validation being equivalent to a request to change the quality of service level for the current connection. It is noted that the request CF_REQ may also have been issued on another communication interface than the one used by the item of client equipment E_CL to connect to the item of server equipment E_S (via the access network RC1).

In 32, the device 100 transmits to a quality of service management entity EGCF1 a request CF_SET to update its connection in its access network RC1. This request comprises the item of activation information AC_QoS received, for example, the pair of IP addresses (@IP_CL,@IP_S), possibly supplemented by the port number of the item of client equipment or the connection token JCF.

It is noted that this update request is first received by the item of routing equipment ER1, which, due to its position, receives all the data packets and messages transmitted by the item of client equipment E_CL, and that it forwards them to the management entity EGCF1.

In 33, it receives a response from the management entity ECGF1 of said network RC1. For example, this is a positive response CF_OK which confirms that its update request has been processed and that it now benefits from the second level of service QoS2 for its connection with the item of server equipment E_S.

In 35, it transmits a data packet to said item of server equipment E_S regarding this connection. This data packet comprises said item of activation information AC_QoS of a second quality of service level. It is understood that in case this item of activation information comprises information fields usually present in a header of this data packet, such as the pair of IP addresses (@IP_CL, @IP_S), the device 100 does not have to perform any prior action before transmitting the data packet. However, when the item of activation information AC_QoS comprises the connection token JCF, it inserts in 34 the connection token JCF into an information field of a header of the data packet before sending it in 35.

For example, the information field in question is an unused field of the communication protocol. In relation to FIG. 5A, the IP (Internet Protocol) protocol and the structure of an IP data packet, of type IPv4 or IPv6, are considered as an example. In a known manner, such a data packet comprises several information fields in its header. Advantageously, the connection token JCF is inserted into an information field called “options”, reserved for the implementation of additional functionalities.

In relation to FIG. 4, an embodiment of a method for processing a request to change the quality of service level received by the item of server equipment E_S from the item of client equipment E_CL via the communication network RC is now presented in the form of a flowchart. In the following, this method is implemented by the above-mentioned device 200, for example integrated into the item of server equipment E_S.

In 40, the device 200 receives a request to change the quality of service level CF_REQ from the item of client equipment E_CL. As already described in relation to FIG. 3, this request may be explicit or implicit. It may be the object of a specific message sent to the item of server equipment E_S or be inserted into a particular information field of a request to establish a communication with the item of server equipment set to a given value, intended to be interpreted by the item of server equipment as a request to change the quality of service level.

In the second (implicit) case, the mere receipt of a connection request with the item of server equipment E_S is interpreted and processed by the device 200 as a request to change the quality of service level and will be interpreted as such by the item of server equipment E_S. The decision to process a particular connection request as a request to change the quality of service level may also depend on a type of application connection with the item of server equipment and a priori knowledge of the nature of the data that will be exchanged (volume, latency, etc.).

In 42, the device 200 decides whether to respond positively or negatively to this request. Optionally, in a preliminary step 41, it verifies the available resources, for example in terms of number of quality of service changes granted to other client equipment. For example, it is assumed that the item of server equipment E_S has negotiated a number N, with N being a non-zero integer, for example equal to 10, of concurrent updates over a given period of time and it maintains a counter CT. As long as the counter has a value less than or equal to N-1, it accepts the request, otherwise it rejects it.

In case of rejection, it issues in 46 a negative response CF_NOK.

If it accepts the request of the item of client equipment E_CL, then it declares in 44 the connection with this item of client equipment in the data table DB_GCF_IO. This declaration comprises recording in an entry of the table an item of activation information of a second quality of service level AC_QoS for this connection with the item of client equipment E_CL. According to a first embodiment of the present disclosure, this item of information comprises an item of identification information of the connection, such as the pair of IP addresses (@IP_CL,@IP_S). It is therefore constituted of information usually present in the messages exchanged between the item of client equipment and the item of server equipment E_S during the connection. According to a second embodiment, it comprises a connection token JCF previously obtained by the device 200 in 43. For example, the device 200 generates this connection token JCF specifically in response to the request of the item of client equipment E_CL. It is for example a hash code, whose calculation can advantageously involve identification and/or temporal and spatial location information of the item of client equipment E_CL, such as its login, access password to a service of the item of server equipment, GPS coordinates or mailing address of the user, or even a temporal interval.

Such information concatenated together with other information helps to produce, in a manner known per se, a unique and information-specific code via the application of a hash function. It is understood that the use of such a code as a login token offers increased security. It also allows the validation of the connection update for other communications than those to or from the item of server equipment E_S. In other words, it eliminates the need to associate the destination or source IP address with the item of validation information IV_QoS in the data table DB_GCF_IO. Indeed, according to this second embodiment, the entry of the connection management table DB_GCF_IO comprises an item of identification information of the connection, for example the pair (@IP_CL,@IP_S) associated with said connection token JCF.

Therefore, the use of the connection token offers greater flexibility and is particularly well suited to a teleworking type of use where an employee connects to their company’s network via a virtual private network. With an embodiment of the present disclosure, they benefit from a facilitated connection for all their communications or connections, as long as these are established through their secure connection to their company’s intranet.

Advantageously, an item of validation information IV is recorded in the data table DB_GCF_IO in association with the item of activation information. For example, it is a validity period, equal to 1 hour. It may also be a maximum volume of data exchanged with the connection token (that is benefiting from the QoS update or “facilitated connection”). If the connection token is not single-use, the item of validation information may also specify a number of uses of the token.For example, the data table DB_GCF_IO is organised as an indexed database so that it can be easily accessed, without having to browse all its records, for example from the value of said login token JCF. As a variant, it takes the form of a Json file.

The connection management table DB_GCF_IO is stored in local or remote memory, but in any case, accessible through the communication network RC from any access network, such as RC1 or RC2, to the network RC. This table is indeed intended to be queried by the various access providers to the communication network RC. This aspect will be detailed below in relation to FIG. 5.

In 47, at least one data packet CF_MSG is received from the item of client equipment E_CL according to the conditions of the updated connection. It therefore comprises the item of activation information AC_QoS, for example inserted into a header of the data packet.

It is assumed that the item of server equipment responds with at least one data packet CF_MSG_REP which is therefore processed by the device 200. In 48, the device 200 obtains the item of activation information AC_QoS, JCF, for example stored in memory M2 and inserts it into a header of the data packet before sending it in 49.

The data packet CF_MSG_REP is transmitted in the communication network RC. Since it contains the item of activation information of the second quality of service level, it can be recognised by the item of routing equipment ER1 of the first network RC1 and processed according to the conditions specified by the second quality of service level QoS2.

In relation to FIG. 5, an embodiment of a method for managing the quality of service for a connection between the item of client terminal equipment E_CL and an item of server equipment E_S in the communication network RC, which the item of client equipment accesses via the first access network RC1, is now presented in the form of a flowchart. According to the contract taken out by the user of the item of client equipment E_CL with the access provider operating this first network, a first quality of service level QoS1 is applicable to the data packets exchanged via this connection.

In the following, this method is implemented by the above-mentioned device 400, for example integrated into the quality of service management entity EGCF1

According to this embodiment of the present disclosure, the method comprises in 50 receiving from the item of client equipment a request CF_SET to update said connection of the item of client equipment E_CL to the communication network for the data packets exchanged with said item of server equipment. This request comprises an item of activation information AC_QoS of a second quality of service level. As previously described, this is the first embodiment of identification information of the application connection between the item of client equipment and the item of server equipment, for example the pair of source and destination IP addresses (@IP_CL,@IP_S). According to a second embodiment, this item of activation information AC_QoS comprises a connection token JCF.

In 51, the device 400 detects this item of information IAC_QoS in the received update request CF_SET. It can be comprised in a header or in the useful part of the message. For example, the case of an IP data packet whose header has a structure such as the one shown in FIG. 5A is considered in particular. Advantageously, for such an IP data packet, the item of information IV_QoS is included in the “options” information field of this header.

In 52, the device 400 verifies the validity of this item of information by querying the connection management table DB_GCF_IO at least using the detected item of activation information AC_QoS. If this item of activation information is the connection token JCF, the query further comprises an item of identification information of the connection, for example the pair (@IP_CL, @IP_S). As a variant, the item of activation information comprises only the item of identification information of the connection. If an entry is found in the data table DB_GCF_IO, then the device 400 installs a new quality of service management rule R_QoS2 for the connection. This rule specifies that the second quality of service level QoS2 must be assigned to the processing of a data packet exchanged regarding the connection between the item of client equipment E_CL and the item of server equipment E_S (in the uplink direction and/or downlink direction), when this data packet includes the item of activation information AC_QoS of a second quality of service level.

Advantageously, the installation of this rule RQoS2 includes its storage in a local M4 memory. For example, this memory is organised as a data table that stores the set of quality of service rules to apply to the processing of the data packets implemented in the application connections involving items of client equipment connected to the communication network RC1. In particular, it already includes at least one rule R_QoS1 for managing the quality of service of the data packets exchanged by the item of client equipment E_CL in accordance with the subscription they have taken out.

As a variant, the rule R_QoS2 is passed to the item of routing equipment ER1 in charge of controlling the data traffic between the item of client equipment E_CL and the first network RC1, for storage.

According to an embodiment of the present disclosure, the management rule RQoS2 further specifies a type of service (ToS) to be used for flagging the data packets that need to be processed by applying the second quality of service level. The Type-of-Service (ToS) field allows packet flagging regarding a DiffServ (Differentiated Service) network architecture, described in the paper RFC2474 “Definition of the Differentiated Services Field (DS Field) in the IPv4 and IPv6 Headers” published by the IETF in December 1998, which specifies a mechanism for classifying and controlling traffic, differentiating quality of service management by type of service. DiffServ operates according to a traffic ranking principle, placing each data packet into one of a limited number of traffic classes (or types of service). Each traffic class can be managed differently, ensuring a preferential treatment for higher priority traffic on the network. The principle of Diffserv is that complicated functions such as packet classification and control can be performed on the periphery of each network through which the data packet travels by a routing device configured to recognise the traffic class read from the ToS header and apply the expected QoS treatment to it, because it is known to all networks implementing this architecture. Advantageously, a specific type of service ToS_CF is defined for the facilitated connection service proposed by the present disclosure.

In 54, the device 400 responds to the connection update request with a confirmation message CF_SET_OK when the update can be performed and with an error message CS_SET_NOK otherwise.

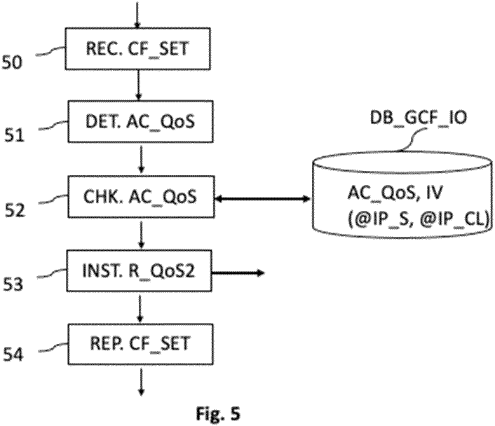

In relation to FIG. 6 an embodiment of a method of processing a data packet exchanged between the item of client terminal equipment E_CL and the item of server equipment E_S in the communication network RC, which the item of client equipment accesses via the first access network RC1 is now presented in the form of a flowchart. According to the contract taken out by the user of the item of client equipment E_CL with the access provider operating this first network, a first quality of service level QoS1 is applicable to said data packet.

According to this example of an embodiment of the present disclosure, the method implements in 60 the reception of at least one data packet CF_MSG exchanged between the item of client equipment E_CL and the item of server equipment E_S. It should be noted that this data packet can be transmitted by the item of client equipment to the item of server equipment or vice versa. In 61, the device 300 detects the item of activation information AC_QoS of the second quality of service level in the data packet. For example, this item of information is included in a header of the data packet or in its useful part.

In 62, the device 300 obtains the quality of service management rule R_QoS2 associated with said second quality of service level. For example, it is stored in its memory M3.

According to an embodiment, when the data packet is an IP packet, it further detects the specific service class ToS_CF in the ToS information field of the packet header and obtains the management rule R_QoS2 associated with that service class.

In 63, it applies the obtained rule to the routing of said data packet CF_MSG, which triggers the allocation of network resources corresponding to the second quality of service level QoS2. As a result, the item of client equipment benefits from an updated connection for data packet routing regarding the connection it has established with the item of server equipment E_S.

In 64, the device 300 obtains an item of information ICRS for counting the resources allocated and thus consumed to route the data packet under the conditions specified by the second quality of service level QoS2, and stores it for example in M3 memory. This includes, for example, a transmitted volume of data, a data rate, etc. Advantageously, such an item of information is obtained and stored for each data packet processed according to the facilitated connection mechanism of the present disclosure. The information obtained and stored for a given period of time will then be concatenated in order to be transmitted to another entity of the first network RC1, for example the entity EGCF1 which collects the resource consumption information by the first network RC1 before being retransmitted it to a billing entity in order to be re-billed to the provider of the second access network RC2 according to a given inter-operator billing policy.

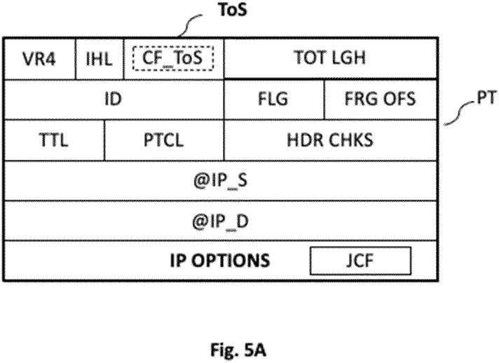

In relation to FIG. 7, the messages exchanged between the different items of equipment of the system S for managing a quality of service level to be assigned to data packets exchanged regarding an application connection established or being established between the item of client equipment E_CL and the item of server equipment E_S according to an embodiment of the present disclosure are now described.

In 30, the item of client equipment E_CL sends a request to change the quality of service CF_REQ to the item of server equipment E_S for the connection. It is received in 40 by the item of server equipment E_S. This request may be implicit or explicit and transmitted according to the interface of the communication through which the connection is established or according to another interface. In 41-45, the item of server equipment E_S processes the request. Advantageously, it verifies that it has sufficient rights to grant this quality of service level change to the item of client equipment E_CL and, if so, it obtains an item of activation information of a second quality of service level AC_QoS. Advantageously, it generates a unique connection token JCF and stores it in a dedicated connection management table DB_GCF_IO. In this embodiment example, the table DB_GCF_IO is shared by the different access providers to the communication network RC. The item of server equipment E_S does not access it directly but requires the declaration of the item of validation information IV_QoS = JCF with an item of network equipment configured to manage the access to the table DB_GCF, for example a quality of service management entity EGCF2. This entity is advantageously configured to register the item of activation information AC_QoS in association with at least one item of identification information of the connection. The item of server equipment E_S receives a confirmation of this recording JCF_SET_OK in 45. The item of server equipment E_S confirms in 46 to the item of client equipment E_CL that its request has been accepted and processed (CF_REQ_OK). This confirmation includes the item of activation information IV_QoS, JCF. It is received by the item of client equipment E_CL in 31 via the communication interface used for the connection or another one (SMS, e-mail, etc.). The item of client equipment E_CL extracts the item of activation information AC_QoS, JCF and triggers in 32 the transmission of an update request CF_SET_REQ to its access network RC1L. This request includes the item of activation information IV_QoS, JCF. It is received in 50 by the service quality management entity EGCF1. The latter extracts the item of activation information AC_QoS, JCF in 51 and uses the extracted item of information to verify that the update request is valid with the connection management table DB_GCF_IO. In case of a positive response received in 52, the entity EGCF1 updates the connection of the item of client equipment E_CL by installing an additional quality of service management rule R_QoS2 associated with the item of activation information IV_QoS, JCF. This rule specifies that the resources corresponding to a second quality of service level QoS2 must be assigned to the data packets exchanged regarding the connection between the item of client equipment E_CL and item of server equipment E_S instead of the first quality of service level QoS1 provided for in the subscription taken out by the user of the item of client equipment with the access provider operating the first network RC1. In 54, the management entity EGCF1 confirms to the item of client equipment E_CL that its connection has been updated (CF_SET_OK). This confirmation is received in 33 by the item of client equipment E_CL. In 34, it inserts the item of activation information AC_QoS, JCF into a data packet CF_MSG that it transmits to the item of server equipment E_S. The data packet CF_MSG is received by the item of routing equipment ER1 which detects the item of activation information AC_QoS, JCF present in the packet, retrieves the quality of service management rule R_QoS2 and applies it to the processing of the packet routing (61-63). The data packet is therefore transmitted to the item of server equipment under the conditions specified by the second quality of service level QoS2. It is received by the item of server equipment E_S. It is assumed that the latter responds by transmitting a data packet CF_MSG_REP in 48. Beforehand, it inserts in 47 the item of activation information AC_QoS, JCF of the second quality of service level in the data packet CF_MSG_REP. In this way, when the data packet arrives in the network RC1 of the item of client equipment E_CL, it is processed in 61-63 by the item of routing equipment ER1 by applying the quality of service management rule R_QoS2. In this way, the data packet CF_MSG_REP is also routed to the item of client equipment E_CL with the second quality of service level QoS. The network resources consumed to apply the second quality of service level to the data packet are counted in 64 and stored in memory, for future billing to the access provider operating the second network RC2. For example, they are collected at the entity EGCF1 that manages connection updates for all items of client equipment in the first network RC1, and then possibly passed on to a dedicated billing entity.

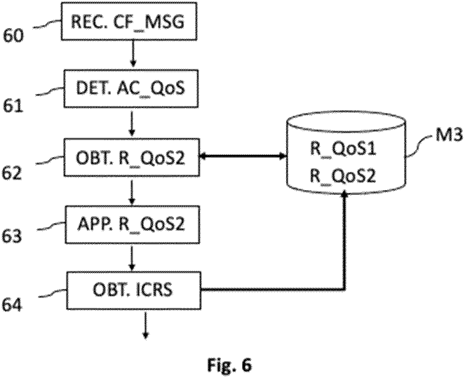

In relation to FIG. 8, an example of material structure of a device 100 for processing a data packet exchanged between an item of client terminal equipment and an item of server equipment of a communication network, which the item of client equipment accesses via a first communication network is then presented, said device comprising a module for detecting in said data stream at least one item of activation information of a second quality of service level to be applied to said data packet, a module for obtaining a quality of service management rule associated with said second quality of service level, and a module for applying said rule to the routing of said data packet between the item of client equipment and the item of server equipment.

The term “module” can correspond to a software component as well as to a hardware component or a set of hardware and software components, a software component itself corresponding to one or more computer programs or sub-programs, or more generally, to any element of a program capable of implementing a function or set of functions.

More generally, such a device 100 comprises a random access memory 103 (a RAM memory, for example), a processing unit 102 equipped for example with a processor and controlled by a computer program Pg1, representative of the above mentioned modules, stored in a read-only memory 101 (a ROM memory or hard disk, for example). At initialisation, the code instructions of the computer program are for example loaded into a random access memory 103 before being executed by the processor of the processing unit 102. The random access memory 103 may also contain, for example, the item of validation information of the second quality of service level, the quality of service management rule, the item of counting information of the amount of network resources consumed.

FIG. 8 only shows a particular one of several possible ways of realising the device 100, so that it executes the steps of the method for processing a data stream as detailed above, in relation to FIGS. 5 and 6 in its various embodiments. Indeed, these steps may be implemented indifferently on a reprogrammable computing machine (a PC computer, a DSP processor or a microcontroller) executing a program comprising a sequence of instructions, or on a dedicated computing machine (for example a set of logic gates such as an FPGA or an ASIC, or any other hardware module).

In the case where the device 100 is realised with a reprogrammable computing machine, the corresponding program (i.e. the sequence of instructions) can be stored in a removable (such as, for example, an SD card, a USB flash drive, CD-ROM or DVD-ROM) or non-removable storage medium, this storage medium being partially or totally readable by a computer or a processor. The various embodiments have been described above in relation to a device 100 integrated into an item of routing equipment of the first communication network RC1 through which the item of client equipment accesses the communication network RC. Of course, embodiments of the present disclosure are not limited to this example, as the device 100 can also be integrated into another equipment of the first network RC.

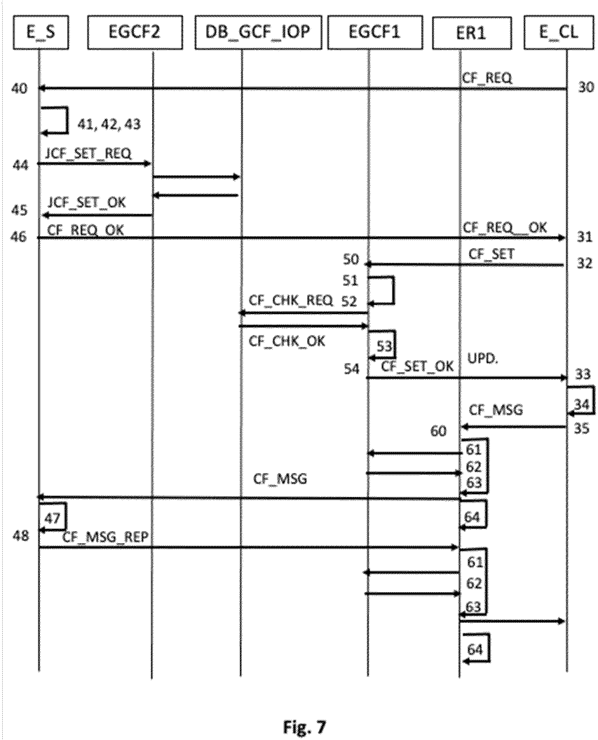

In relation to FIG. 9, an example of hardware structure of a device 200 for processing request to change the quality of service level received by an item of server equipment from an item of client equipment via a communication network, which said item of client equipment accesses via a first network, comprising a module for receiving said request to change the quality of service level, a module for deciding whether to accept the received request to change the quality of service level, a module for recording in a data table, known as the connection management table, accessible from the communication network, at least one item of validation information of a second quality of service level applicable to the routing of the streams exchanged between said item of client equipment and said item of server equipment is then presented.

Advantageously, the device 200 comprises a module for obtaining a connection token, a module for recording said connection token as an item of validation information of the second quality of service level in the data table in association with said item of identification information of the item of client equipment and said item of identification information of the item of server equipment, and a module for transmitting a response to said item of client equipment, the response comprising said connection token.

The term “module” can correspond to a software component as well as to a hardware component or a set of hardware and software components, a software component itself corresponding to one or more computer programs or sub-programs, or more generally, to any element of a program capable of implementing a function or set of functions.

More generally, such a device 200 comprises a random access memory 203 (a RAM memory, for example), a processing unit 202 equipped for example with a processor and controlled by a computer program Pg2, representative of the above mentioned modules, stored in a read-only memory 101 (a ROM memory or hard disk, for example). At initialisation, the code instructions of the computer program are for example loaded into a random access memory 203 before being executed by the processor of the processing unit 202. The random access memory 203 may also contain, for example, the item of validation information of the second quality of service level, the connection token, the item of identification information of the item of client equipment, etc.

FIG. 9 only shows a particular one of several possible ways of realising the device 200, so that it executes the steps of the method for processing a request to change the quality of service level of a connection as detailed above, in relation to FIGS. 4 and 7 in its different embodiments. Indeed, these steps may be implemented indifferently on a reprogrammable computing machine (a PC computer, a DSP processor or a microcontroller) executing a program comprising a sequence of instructions, or on a dedicated computing machine (for example a set of logic gates such as an FPGA or an ASIC, or any other hardware module).

In the case where the device 200 is realised with a reprogrammable computing machine, the corresponding program (i.e. the sequence of instructions) can be stored in a removable (such as, for example, an SD card, a USB flash drive, CD-ROM or DVD-ROM) or non-removable storage medium, this storage medium being partially or totally readable by a computer or a processor. The various embodiments have been described above in relation to a device 200 integrated into the item of server equipment. Of course, embodiments of the present disclosure are not limited to this example, as the device 100 can also be integrated into any CPE equipment with access to the communication network, such as a residential or business gateway, through which the item of server equipment E_S connects to the access network R_FAI_S.

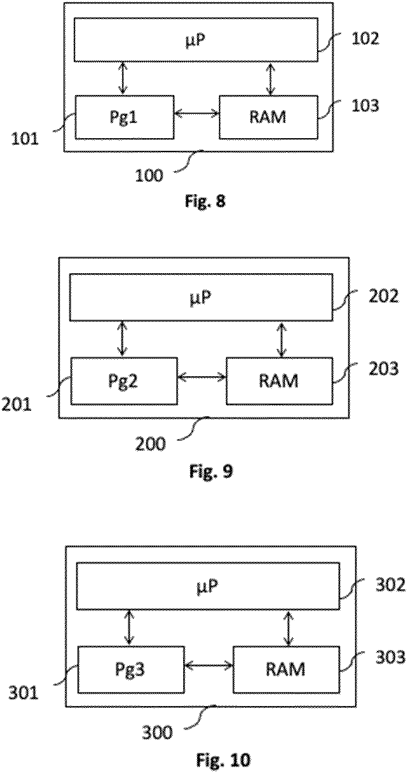

In relation to FIG. 10, an example of the hardware structure of a device 300 for requesting to change the quality of service level, a request being sent by an item of client equipment to an item of server equipment in a communication network, which said item of client equipment accesses via a first network, comprising a module for receiving a response from the item of server equipment, said response comprising an item of validation information of a second quality of service level, said second quality of service level being applicable to the data streams exchanged between the item of client equipment and the item of server equipment, a module for sending a request to update the connection to an item of control equipment of said communication network, said update request comprising said item of validation information of a second quality of service level and a module for transmitting a data stream to said item of server equipment comprising said item of validation information of a second quality of service level is now presented.

The term “module” can correspond to a software component as well as to a hardware component or a set of hardware and software components, a software component itself corresponding to one or more computer programs or sub-programs, or more generally, to any element of a program capable of implementing a function or set of functions.

More generally, such a device 300 comprises a random access memory 303 (a RAM memory, for example), a processing unit 302 equipped for example with a processor and controlled by a computer program Pg3, representative of the above mentioned modules, stored in a read-only memory 101 (a ROM memory or hard disk, for example). At initialisation, the code instructions of the computer program are for example loaded into a random access memory 303 before being executed by the processor of the processing unit 302. The random access memory 303 may also contain, for example, the item of validation information of the second quality of service level, the item of identification information of the item of server equipment, etc.

FIG. 10 only shows a particular one of several possible ways of realising the device 300, so that it executes the steps of the method for requesting to change the quality of service level of a connection as detailed above, in relation to FIGS. 3 and 7 in its different embodiments. Indeed, these steps may be implemented indifferently on a reprogrammable computing machine (a PC computer, a DSP processor or a microcontroller) executing a program comprising a sequence of instructions, or on a dedicated computing machine (for example a set of logic gates such as an FPGA or an ASIC, or any other hardware module).

In the case where the device 300 is realised with a reprogrammable computing machine, the corresponding program (i.e. the sequence of instructions) can be stored in a removable (such as, for example, an SD card, a USB flash drive, CD-ROM or DVD-ROM) or non-removable storage medium, this storage medium being partially or totally readable by a computer or a processor. The various embodiments have been described above in relation to a device 300 integrated into the item of client equipment. Of course, embodiments of the present disclosure are not limited to this example, as the device 100 can also be integrated into any CPE equipment with access to the communication network, such as a home or professional gateway, through which the item of client equipment E_CL connects to the access network RC1.

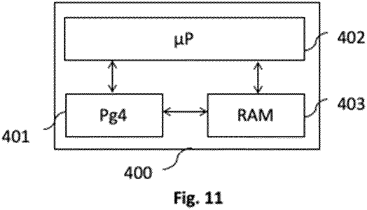

Finally, in relation to FIG. 11, an example of the hardware structure of a device 400 for requesting the management of the quality of service of a connection between an item of client equipment and an item of server equipment in a communication network, which said item of client equipment accesses via a first network, comprising a module for receiving from the item of client equipment a request to update said connection in order to route the data packets exchanged between said item of client equipment and said item of server equipment, a module for detecting the item of activation information the second quality of service level in said update request, a module for verifying that the second quality of service level is valid, by querying a data table, known as the connection management table, at least from said item of activation information, a module for installing a quality of service management rule in the first network and a module for sending a response to the item of client equipment is presented.

The term “module” can correspond to a software component as well as to a hardware component or a set of hardware and software components, a software component itself corresponding to one or more computer programs or sub-programs, or more generally, to any element of a program capable of implementing a function or set of functions.

More generally, such a device 400 comprises a random access memory 403 (a RAM memory, for example), a processing unit 402 equipped for example with a processor and controlled by a computer program Pg4, representative of the above mentioned modules, stored in a read-only memory 101 (a ROM memory or hard disk, for example). At initialisation, the code instructions of the computer program are for example loaded into a random access memory 403 before being executed by the processor of the processing unit 402. The random access memory 403 may also contain, for example, the item of validation information of the second quality of service level, the item of identification information of the item of server equipment, etc.

FIG. 11 only shows a particular one of several possible ways of realising the device 400, so that it executes the steps of the method for managing the quality of service of a connection as detailed above, in relation to FIGS. 5 and 7 in its different embodiments. Indeed, these steps may be implemented indifferently on a reprogrammable computing machine (a PC computer, a DSP processor or a microcontroller) executing a program comprising a sequence of instructions, or on a dedicated computing machine (for example a set of logic gates such as an FPGA or an ASIC, or any other hardware module).

In the case where the device 400 is realised with a reprogrammable computing machine, the corresponding program (i.e. the sequence of instructions) can be stored in a removable (such as, for example, an SD card, a USB flash drive, CD-ROM or DVD-ROM) or non-removable storage medium, this storage medium being partially or totally readable by a computer or a processor. The various embodiments have been described above in relation to a device 400 integrated into the management entity EGCF1. Of course, embodiments of the present disclosure are not limited to this example, as the device 400 can also be integrated into any item of equipment of the first network RC1, and in particular into the item of routing equipment ER1.

One or more exemplary embodiments of the present disclosure just described have many advantages. They offer to go beyond the static quality of service management at source that is implemented today, by a dynamic quality of service management that can under certain conditions be determined by the destination. The present disclosure thus offers the possibility to go beyond a first contractual quality of service level assigned to an item of client equipment and giving it the benefit of a second quality of service level, higher than the first, for one or more application connections to an item of server equipment. This second quality of service level is specified by a contract that binds the entity managing the item of server equipment to its access provider, and the item of server equipment that decides under which conditions and to which item of client equipment it grants this change of quality of service level.

The relevant application connection is then qualified by an attribute (item of activation information of the second quality of service level, e.g. a connection token) recorded in a data table accessible from the communication network by the different access network operators. This attribute is inserted into the data packets exchanged between the item of client equipment and the item of server equipment, allowing the item of client equipment’s access network to apply the second quality of service level determined by the destination instead of the first quality of service level regarding the application connection, to track the resource consumption caused by this change and to bill the item of server equipment’s access provider.

An embodiment of the present disclosure thus provides the basis for a new service for Internet access providers, intended for their subscribers, professionals in particular, who manage one or more items of server equipment to which items of client equipment connect. This service allows an item of server equipment to offer to all or part of the items of client equipment that connect to it a given and guaranteed quality of service level, in order to facilitate access to its services.

The targeted use cases are numerous and concern in particular the following economic sectors:
Electronic commerce or e-commerce: the present disclosure allows, in particular, to facilitate access to an online shopping portal for users of items of client equipment having a limited Internet connection, not because of the existing physical infrastructure, but because of the subscription they have taken out with their access provider (low-speed domestic connection or a mobile connection with a low or used up monthly data volume). The entity that manages the item of server equipment negotiates a facilitated connection contract with its Internet access provider, in terms of quality of service level, data volume, data rate, number of simultaneous facilitated connections, etc., and bears the additional costs for its website users. Advantageously, it can evolve its economic model by adding modest additional costs to each transaction concluded with an item of client equipment that benefited from a facilitated connection, which will enable it to finance the extra cost of this contract;
Remote access to a company’s intranet via a virtual private network (VPN) for the employees of this company. The present disclosure provides employees with a uniform access to the company network, without the employer having to subsidise an Internet installation for their employees on a case-by-case basis;
Remote learning on a web platform. The present disclosure ensures a uniform level of connectivity to all participants;
Teleconsultation;
Customer relations in B2B mode (Business to Business), to facilitate the implementation of a remote demonstration session of a product by an industrial group to its customers, who may connect through various equipment and interfaces;
etc.

Although the present disclosure has been described with reference to one or more examples, workers skilled in the art will recognize that changes may be made in form and detail without departing from the scope of the disclosure and/or the appended claims.

1. A method comprising:
processing a data packet exchanged between an item of client terminal equipment and an item of server equipment in a communications network, which the item of client equipment accesses via a first network, a first quality of service level being intended to be applied to said data packet, said processing being implemented by an item of routing equipment of said first network and comprising:
detecting in said data packet at least one item of activation information of a second quality of service level to be applied to said data packet;
obtaining a quality of service management rule according to the second quality of service level, associated with said item of activation information; and
applying the second quality of service level to the routing of said data packet according to the obtained rule, instead of the first quality of service level.

2. The method according to claim 1, wherein the item of activation information of a second quality of service level comprises an item of identification information of a source of the data packet and an item of identification information of a destination of the data packet.

3. The method according to claim 1, wherein the item of activation information of a second quality of service level comprises a connection token.

4. The method according to claim 1, wherein said quality of service management rule comprises an item of information relating to a type of service and the application of said rule comprises inserting said item of information in a header of the data packet.

5. The method according to claim 1, wherein the method comprises obtaining an item of count information of a quantity of resources allocated for routing said stream in application of the second quality of service level and recording said item of information.

6. A method comprising:
processing a request to change a quality of service level of a connection from an item of client equipment to an item of server equipment in a communication network which the item of client equipment accesses via a first network of an access provider, a first quality of service level being applied by the first network to data packets exchanged in said connection, said request being received by the item of server equipment from the item of client equipment in the communication network, which said item of client equipment accesses via the first network, wherein the processing is implemented by the server equipment and comprises, upon reception of said request to change the quality of service level:
deciding whether or not to accept the received request to change the quality of service level;
in response to the server equipment deciding to accept the request to change the quality of service, recording in a data table, known as a connection management table, accessible from the communication network, at least one item of activation information of a second quality of service level applicable to routing of the data packets exchanged between said item of client equipment and said item of server equipment; and
transmitting a response to the item of client equipment.

7. The method according to claim 6, wherein the method further comprises:
obtaining a connection token,
recording said connection token as an item of activation information of the second quality of service level in the data table in association with said item of identification information of the item of client equipment and said item of identification information of the item of server equipment; and
wherein the response to the item of client equipment comprises said connection token.

8. A method comprising:
requesting to change a quality of service level of a connection of an item of client equipment to an item of server equipment in a communication network which the item of client equipment accesses via a first network, a first quality of service level being applied by the first network to data packets exchanged in said connection, wherein the requesting is implemented by the item of client equipment and further comprises:
receiving a response from the item of server equipment, said response comprising an item of activation information of a second quality of service level, said second quality of service level being applicable to data packets exchanged between the item of client equipment and the item of server equipment;
transmitting a request to update the connection to an item of control equipment of said communication network, said update request comprising said item of activation information of a second quality of service level; and
inserting the item of activation information of a second quality of service level in a data packet and transmitting said data packet in the first network.

9. A method comprising:
managing a quality of service of a connection of an item of client equipment to an item of server equipment in a communication network which the item of client equipment accesses via a first network, a first quality of service level being applied by the first network to data packets exchanged in said connection, wherein the managing is implemented by a quality of service management entity of the first network and comprises:
receiving from the item of client equipment a request to update said connection for routing data packets exchanged between said item of client equipment and said item of server equipment;
detecting an item of activation information of the second quality of service level in said update request;
verifying a validity of the item of activation information by querying a data table, known as a connection management table, at least from said item of activation information and an item of identification information of the item of server equipment; and
installing a quality of service management rule according to the second quality of service level associated with said item of activation information of the second quality of service level for said connection and
transmitting a response to the item of client equipment.

10. A device comprising:
a processor configured to process a data stream exchanged between an item of client terminal equipment and an item of server equipment via a communications network, to which the item of client equipment is connected with a first quality of service level, wherein said device is configured to implement at an item of equipment of said communication network and the processing comprises:
detecting in said data stream at least one item of validation information of a second quality of service level to be applied to said data packet;
obtaining a quality of service management rule according to the second quality of service level, associated with said item of activation information; and
applying the second quality of service level to a routing of said data packet according to the obtained rule, instead of the first quality of service level.

11. A device comprising
a processor configured to process a request to change a quality level of a connection from an item of client equipment to an item of server equipment in a communication network which the item of client equipment accesses via a first network, a first quality of service level being applied by the first network to data packets exchanged in said connection, said request being received by the item of server equipment from the item of client equipment via the communication network, wherein the processor is configured to implement at the item of server equipment:
deciding whether or not to accept the received request to change the quality of service level;
in response to the device deciding to accept the received request to change the quality of service level, recording in a data table, known as a connection management table, at least one item of validation information of a second quality of service level applicable to a routing of the streams exchanged regarding a communication between said item of client equipment and said item of server equipment.

12. A device comprising:
a processor configured to request to change a quality of service level of a connection of an item of client equipment to an item of server equipment in a communication network which the item of client equipment accesses via a first network, a first quality of service level being applied by the first network to data packets exchanged in said connection, wherein the processor is configured to implement at the item of client equipment:
receiving a response from the item of server equipment, said response comprising an item of activation information of a second quality of service level, said second quality of service level being applicable to data packets exchanged between the item of client equipment and the item of server equipment;
transmitting a request to update the connection to an item of control equipment of said communication network, said update request comprising said item of activation information of a second quality of service level; and
inserting the item of activation information of a second quality of service level in a data packet and transmitting said data packet in the first network.

13. A device comprising:
a processor configured to manage a quality of service of a connection of an item of client equipment to an item of server equipment in a communication network which the item of client equipment accesses via a first network, a first quality of service level being applied by the first network to data packets exchanged in said connection, wherein the processor is configured to implement at a quality of service management entity of the first network:
receiving from the item of client equipment a request to update said connection for routing data packets exchanged between said item of client equipment and said item of server equipment;
detecting an item of activation information of the second quality of service level in said update request;
verifying a validity of the item of activation information by querying a data table , known as a connection management table, at least from said item of activation information and an item of identification information of the item of server equipment; and
in response to the device verifying that the item of activation information is valid, recording the item of activation information in a memory in association with the item of identification information of the item of server equipment and an item of identification of the item of client equipment;
installing a quality of service management rule associated with the second quality of service level for said connection; and
transmitting a response to the item of client equipment.
